(19) United States
(12) Patent Application Publication
(10) Pub. No.: US 2004/0117397 A1
(43) Pub. Date: Jun. 17, 2004

(54) Extensible database system and method

(76) Inventor: Robert J. Rappold III, Quinton, VA (US)

Correspondence Address: Baker Botts L.L.P., Suite 600, 2001 Ross Avenue, Dallas, TX, 75201-2980, US

(21) Appl. No.: 10/320,831

(22) Filed: Dec. 16, 2002

(51) Int. Cl. G06F 17/00

(52) U.S. Cl. 707/102

(57) ABSTRACT

An extensible database system and method is provided, which allows dynamic changes to be made to a relational database without requiring the use of a DDL. The database design allows the dynamic creation during run-time of new tables and columns, elimination of columns, and changes to column datatypes and lengths to be accomplished without the use of a DDL. The extensible database system and method includes a data table, which stores various attributes, and a metadata table, which provides parameters and formatting information for the attributes stored in the data table.

### TECHNICAL FIELD OF THE INVENTION

The present invention relates in general to the database development field and, in particular, to an extensible database system and method.

### BACKGROUND OF THE INVENTION

Relational databases are widely used for the storage and retrieval of information, and are currently supported by a majority of database vendors. Traditional relational databases use sets of schemas to describe the tables, columns, and relationships in the tables using basic principles known in the field of database design. Among other contributions, these principles permit the storage of data in a relatively small amount of disk space, but at the expense of extensibility during run-time. Currently, the schemas can be defined and manipulated by a database administrator (DBA) using a data definition language (DDL). Such schemas are typically fixed when the table is created, and these fixed schemas allow very limited changes in a dynamic manner.

For example, as a database application is being run, and a need for a new column is discovered at run-time, fixed schemas do not permit the table structure of a relational database to be changed without the use of a DDL. Specifically, the actions of defining new tables and columns and making changes to attribute datatypes and sizes require the execution of DDL statements.

Also, although existing relational databases allow the use of a DDL to add new columns, these changes may affect all of the new and existing rows in the table, rather than just the rows that require the new columns' information. Thus, the user's ability at run-time to change the relational database's ability to store new or changed information is limited.

In order to use DDL in the manner described above, a separate structured query language (SQL) is developed for each type of table being processed. Accordingly, the productivity of database developers is decreased. Furthermore, existing database engines are typically unable to cache all SQL statements, or process many similar SQL statements in batch modes. This may degrade the performance of the database engine used.

### SUMMARY OF THE INVENTION

In accordance with the present invention, an extensible database allows dynamic changes to be made to a relational database without requiring the use of a DDL. The database design allows the dynamic creation during run-time of new tables and columns, elimination of columns, and changes to column datatypes and lengths to be accomplished without the use of a DDL. In accordance with a particular embodiment of the present invention, an extensible database includes a data table and a metadata table.

A technical advantage of particular embodiments of the present invention includes an extensible database that can be readily incorporated by an application user that currently uses, or desires to use, relational database technology. Also, in accordance with some embodiments, the extensible database system and method can be used with any type of existing relational database system, such as, for example, an Access®, DB2®, or Oracle® database system.

Another technical advantage of particular embodiments of the present invention is that the extensible database system and method enables a user to store new data in a table without having to create new columns or define a new table using DDL. As a result, the behavior of database applications can be adjusted during run-time, instead of having to restrict the persistence layer processing only to what can be handled by the existing schema.

Yet another technical advantage of particular embodiments of the present invention is that the extensible database system and method allows for significant flexibility in making design decisions by enabling a user to setup database tables with conventional schema and the invention's unique design and then change the schema at run-time, thereby enabling systems to effectively handle dynamic adaptation, agent processing in new environments, and rapidly changing data requirements. This permits faster and less expensive database development and rapid adjustments to new requirements, provides new capabilities for existing database applications, and does not require the use of new database management software.

Still another technical advantage of particular embodiments of the present invention is that the extensible database system and method enable the use of standardized SQL, such as standardized and pre-tested access, update, delete, insert, and transformational logic, and thereby allow the massive re-use of code. As such, a common SQL statement can be used for handling multiple tables, instead of having to code separate SQL statements for each table and combination of possibilities.

Other technical advantages will be readily apparent to one skilled in the art from the following figures, descriptions and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates a database system in accordance with the present invention, wherein a metadata table provides parameters for attributes stored in a corresponding data table;

FIG. 2 illustrates a data table in accordance with the present invention, wherein each row of the data table stores information regarding a single attribute of a logical entity;

FIG. 3 illustrates a metadata table in accordance with the present invention, wherein the rows of the metadata table provide parameters and formatting information for the entries in the data table in FIG. 1;

FIG. 4 illustrates a later version of the metadata table shown in FIG. 3, wherein an additional metadata table row has been added to the metadata table, allowing for an additional attribute type to be stored in the data table;

FIG. 5 illustrates a later version of the data table shown in FIG. 2, wherein additional data table rows have been added, holding attributes of the attribute type added to the metadata table in FIG. 4;

FIG. 6 illustrates an extensible database system, including a transformation module operable to import and export data into and out of the data table;

FIG. 7 illustrates a Petri net depicting a set of transformation logic employed in a transformation module to transform data stored in an extensible database into objects for processing; and

FIG. 8 illustrates a Petri net depicting a set of transformation logic employed in a transformation module to import data into an extensible database.

### DETAILED DESCRIPTION OF THE INVENTION

In accordance with the present invention, an extensible database system and method allows dynamic changes to be made to a relational database without requiring the use of a DDL. Unlike a traditional relational database, the extensible database design allows the dynamic creation during run-time of new tables and columns, elimination of columns, and changes to column datatypes and lengths to be accomplished without the use of a DDL. This is accomplished using a data table, which stores various attributes of various logical entities, and a metadata table, which provides parameters and formatting information for those various attributes.

Each physical row in the data table corresponds to a logical column in a physical row of a relational table, or in other words, each row of the data table holds one attribute. Therefore, there is no need to use a DDL to add a physical row (instead of the conventional practice of using a DDL to add a physical column to a physical table). As a result, the present invention allows the relatively easy addition of new logical columns to a logical table, without requiring the use of a DBA.

For the purposes of this explanation, assume a database holds information relating to the first name, middle initial, last name, username, and phone extension for four individuals. This information is listed in table form below:

| ID# | First | MI | Last | Username | Extension |
|---|---|---|---|---|---|
| 81 | Alice | B | Jones | ajones | x5547 |
| 92 | Frank | | Smith | fsmith | x2234 |
| 93 | John | Q | Public | jpublic | x1234 |
| 97 | James | T | Kirk | jkirk | x1701 |

In the following illustrations, each individual is a single logical entity, and each piece of information about them, such as their first name or phone extension, is an attribute of that logical entity. To link those logical entities to their attributes, each logical entity is given an entity ID (ID#). In the following examples, those entity IDs are the same as the ID numbers in the above table. Therefore, Alice B. Jones's entity ID is “81”, Frank Smith's is “92”, John Q. Public's is “93”, and James T. Kirk's is “97”. Since each logical entity can have more than one attribute, those attributes need to be distinguished. To accomplish this, the various attribute types are given attribute IDs. First names are termed attribute type “1”, middle initials are attribute type “2”, last names are attribute type “3”, usernames are attribute type “4”, and phone extensions are attribute type “5”. Since each attribute is linked to an attribute type and to a logical entity, each attribute can be stored on a different row of the data table, allowing for greater flexibility in managing the database. Storing parameters and formatting information about the attribute types in a metadata table further adds to the flexibility offered by the database system.

Structuring the database in this extensible manner offers several benefits. As mentioned above, if a logical entity has five attributes, each instance of the logical entity in the extensible database can use up to five physical rows, or one row for each attribute. However, if the entity only requires two attributes with non-null values, then only two rows will be needed. As such, there is no need to use a DDL to add a physical row (instead of the conventional practice of using a DDL to add a physical column to a physical table). As a result, the present invention allows the relatively easy addition of new logical columns to a logical table, without requiring the use of a DBA. Furthermore, the use of metadata information permits a string value holding an attribute to be easily and dynamically converted to an appropriate datatype (e.g., number or date) for application processing using unique algorithms. Attribute types can also be changed dynamically by adjusting the metadata table, without needing to use a DDL.

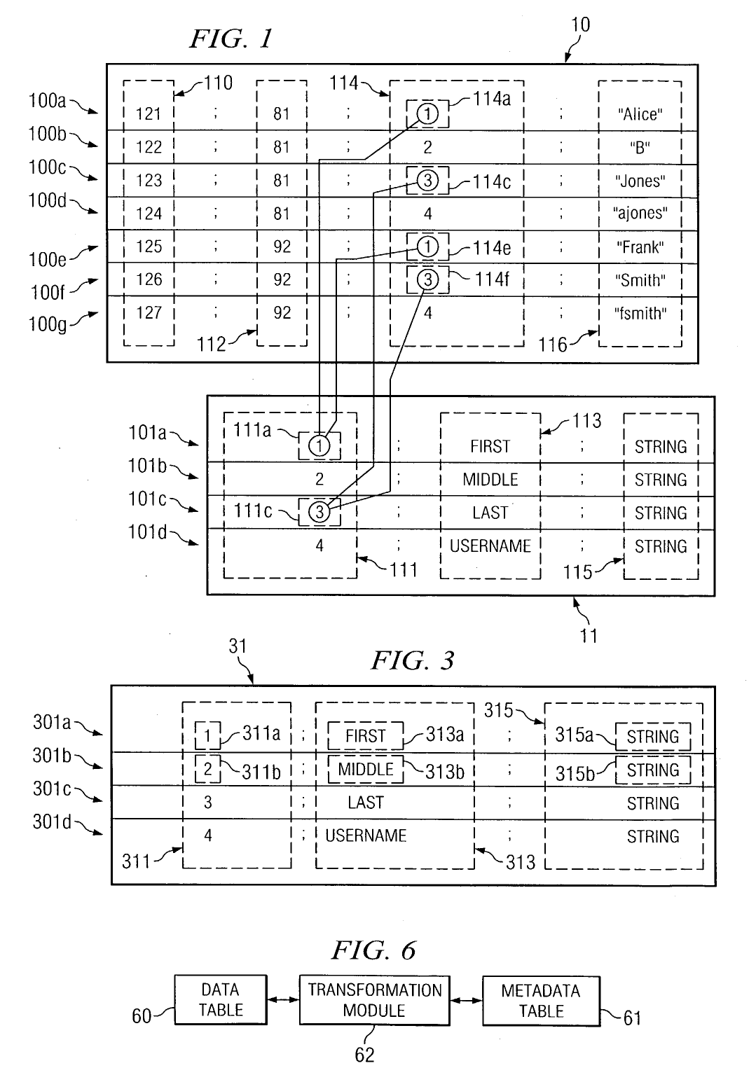

The present invention and its advantages are best understood by referring to FIGS. 1-5 of the drawings, like numerals being used for like and corresponding parts of the various drawings, which represent one embodiment of the present invention.

FIG. 1 shows an abbreviated version of the database, holding information for only the first two individuals listed in the above table and holding only their first names, middle initials, last names, and usernames.

In this example, data table 10 stores the first names, middle initials, last names, and usernames of Alice B. Jones and Frank Smith. Data table 10 is comprised of data table rows 100a-100g and columns 110, 112, 114, and 116. Each row 100 of data table 10 holds one attribute. For example, row 100a holds Alice B. Jones's first name, “Alice”, row 100b holds Alice B. Jones's middle initial, “B”, and so forth. Column 110 holds numbers identifying the individual row 100, similar to a typical relational database. In this example, those numbers run from “121” to “127”. Column 112 holds entity IDs identifying the individual who has an attribute stored on that row 100. Here, those entity IDs are either “81” for Alice B. Jones or “92” for Frank Smith. Each row 100 holding an attribute for either of these entities has that entity's particular entity ID in this column. This links the particular attribute stored on that row to the particular logical entity it describes. Column 114 holds attribute IDs representing the attribute type stored on that row 100. Finally, column 116 holds the actual attributes data table 10 is being used to store. In this case, those are the first names, middle initials, last names, and usernames for Alice B. Jones and Frank Smith.

The other component of the extensible database system shown in FIG. 1 is metadata table 11. Metadata table 11 is comprised of metadata table rows 101a-101d and columns 111, 113, and 115. Each row 101 of Metadata table 11 provides parameters and formatting information for one attribute type stored in data table 10. Column 111 holds numbers representing the attribute type whose parameters and formatting information is provided on that particular row 101 of metadata table 11. These correspond to the entries in column 114 of data table 10, as illustrated by the connections between entry 111a in metadata table 11 and entries 114a and 114e in data table 10. Both data table rows 100a and 100e hold first names, which are of attribute type “1”. As shown by entry 111a, metadata table row 101a provides formatting information for this attribute type, attribute type “1”, or first names. Likewise, the other metadata table rows, rows 101b-101d, also provide parameters and formatting information for other data table rows 100.

Continuing the description of metadata table 11, column 113 of metadata table 11 holds identifiers, or attribute names, for the attribute type whose parameters and formatting information are provided on that particular row 101. Although not necessary, these provide more information about the attribute type. Finally, column 115 holds formatting information for the attribute type whose parameters and formatting information is provided on that particular row 101. In this example, column 115 indicates that all the attribute types are strings.

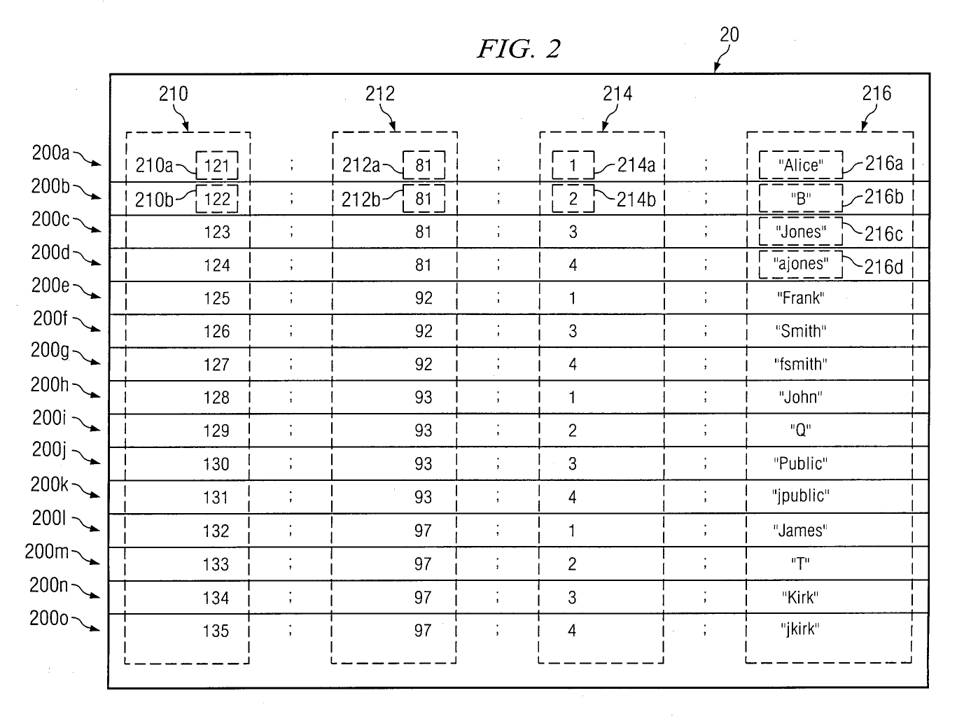

Having illustrated the link between the data table and metadata table of this particular embodiment, a more detailed representation of a data table in accordance with the present invention is shown in FIG. 2. FIG. 2 shows data table 20. Data table 20 is comprised of data table rows 200a-200o and data table columns 210, 212, 214, and 216. Data table row 200a is comprised of entries 210a, 212a, 214a, and 216a; entry 210a being in column 210, entry 212a being in column 212, and so forth. Likewise, data table row 200b is comprised of entries 210b, 212b, 214b, and 216b; entry 210b being in column 210, entry 212b being in column 212, and so forth. The other entries in data table 20 follow a similar numbering scheme.

In this example, data table 20 stores the first names, middle initials, last names, and usernames for all four individuals listed in the logical table detailed above. Column 210 holds numbers identifying the individual row 200, similar to a typical relational database. In this example, those numbers run from “121” to “135”. Column 212 holds entity IDs identifying the individual who has an attribute stored on that row 200. Column 214 holds attribute IDs, representing the attribute type stored on that row 200. Finally, column 216 holds the actual attributes data table 20 is being used to store.

The first seven rows of data table 20 are identical to those of data table 10. However, eight additional rows appear in data table 20. Rows 200h-200k hold four attributes for John Q. Public, and rows 200l-200o hold four attributes for James T. Kirk. Notice rows 200h-200k have “93” as the entry in column 212. This entry is John Q. Public's entity ID and links the particular attributes to him. Since the common entity ID, and not their placement in the data table, link the attributes together, the data table rows holding the various attributes of a logical entity do not need to appear on adjacent rows. Instead, they could appear on any combination of adjacent and nonadjacent rows. This allows for added flexibility in managing the database, and it allows for additional attributes to be added to an entity simply by adding an additional row to the bottom of the data table.

The attribute types of these various attributes are distinguished by the entries in column 214. As mentioned earlier, attribute types “1”, “2”, “3”, and “4” correspond to first names, middle initials, last names, and usernames, respectively. The formatting for these attribute types appears in metadata table 31, illustrated in FIG. 3.

Metadata table 31 is comprised of rows 301a-301d and columns 311, 313, and 315. Each metadata table row 301 provides parameters and formatting information for one attribute type stored in data table 10. The four rows of metadata table 31 are identical to those of metadata table 11. Column 311 of metadata table 31 holds attribute IDs representing the attribute type whose parameters and formatting information are provided on that particular row 301. Column 313 holds identifiers, or attribute names, for the attribute type whose parameters and formatting information are provided on that particular row 301. Finally, column 315 holds formatting information for the attribute type whose parameters and formatting information are provided on that particular row 301. Again, in this example, all attribute types are strings. In other embodiments, the attribute types could be strings, integers, or real numbers, among other datatypes.

Entry 311a indicates that metadata row 301a provides parameters and formatting information for attribute type “1”. Entry 313a indicates that this attribute type has the attribute name “First” (attribute type “1” is for first names). Finally, entry 315a indicates that this attribute type is a string, as opposed to an integer or other datatypes.

Likewise, entry 311b indicates that metadata row 301b provides parameters and formatting information for attribute type “2”. Entry 313b indicates that this attribute type has the attribute name “Middle” (attribute type “2” is for middle initials). Finally, entry 315b indicates that this attribute type is also a string.

Similarly, rows 301c and 301d of the metadata table provide parameters and formatting information for attribute types “3” and “4”, respectively.

Essentially what has happened between FIG. 1 and FIGS. 2-3, is that the eight attributes for John Q. Public and James T. Kirk have been added. Since these were attributes of an existing type (i.e. the attribute types had already been defined in the metadata table), rows holding the attributes were simply added to the data table. All of this was done without the need for a DDL. No additional columns were needed. Therefore, the data table did not need to be reformatted.

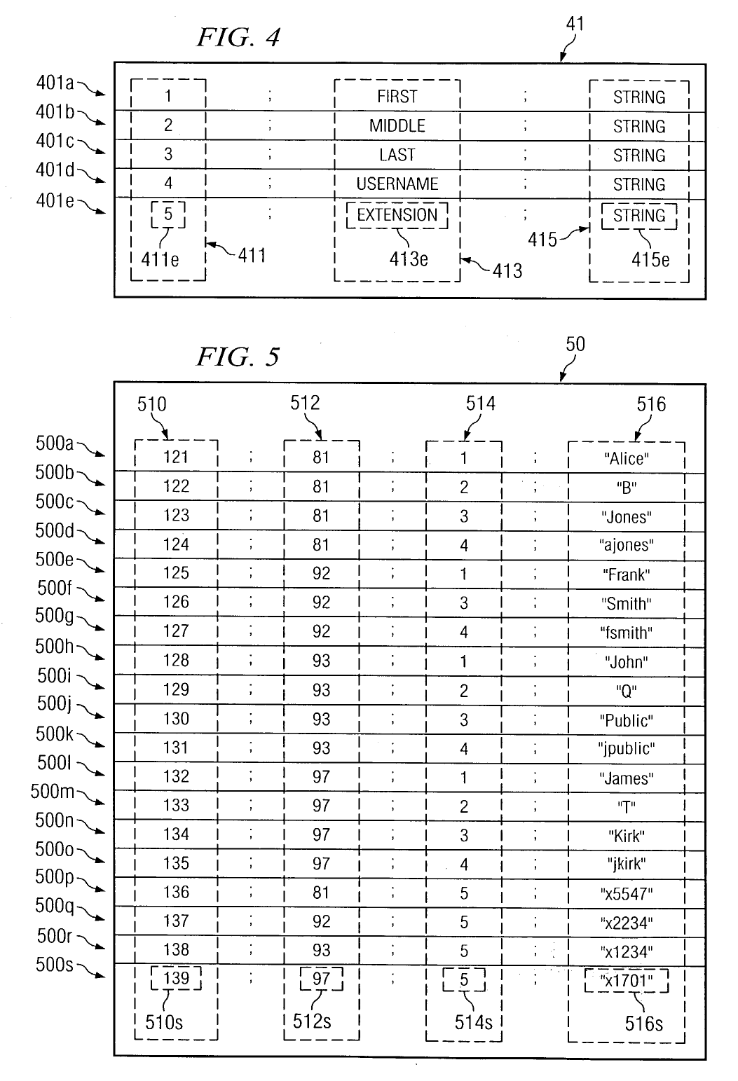

In addition to adding additional attributes of a pre-existing type to a data table, attributes of a new type can be added as well, again without the need for a DDL. An example of this is shown in FIGS. 4 and 5.

FIG. 4 illustrates metadata table 41. Metadata table 41 is a later version of metadata table 31. The first four rows of metadata table 41 are identical to those of metadata table 31. However, metadata table 41 has an additional row, row 401e. Metadata table row 401e provides parameters and formatting information for attribute type “5”, which corresponds to phone extensions. Similar to how additional rows can be added to a data table without the use of a DDL, additional rows can be added to a metadata table without the use of DDL as well.

Similar to before, column 411 of metadata table 41 holds attribute IDs representing the attribute type whose parameters and formatting information are provided on that particular row 401. Column 413 holds identifiers, or attribute names, for the attribute type whose parameters and formatting information are provided on that particular row 401. Finally, column 415 holds formatting information for the attribute type whose parameters and formatting information are provided on that particular row 401. Again, in this example, all attribute types are strings.

With this newly defined attribute type in metadata table 41, new attributes of attribute type “5” can be added to a data table. The resulting data table, data table 50, is shown in FIG. 5.

FIG. 5 illustrates data table 50. Data table 50 is comprised of data table rows 500a-500s and data table columns 510, 512, 514, and 516. Data table row 500a is comprised of entries 510a, 512a, 514a, and 516a; entry 510a being in column 510, entry 512a being in column 512, and so forth. Likewise, data table row 500b is comprised of entries 510b, 512b, 514b, and 516b; entry 510b being in column 510, entry 512b being in column 512, and so forth. The other entries in data table 50 follow a similar numbering scheme.

The first fifteen rows of data table 50 are identical to those of data table 20. However, data table 50 has four additional rows, rows 500p-500s. These additional rows, rows 500p-500s, hold the phone extensions for the four individuals who already have attributes stored in the data table. Similar to before, column 510 holds numbers identifying the individual row 500, similar to a typical relational database. Column 512 holds entity IDs identifying the individual who has an attribute stored on that row 500. Column 514 holds attribute IDs, representing the attribute type stored on that row 500. Finally, column 516 holds the actual attributes data table 50 is being used to store.

As indicated by the entries in column 514 for the four additional rows, these rows hold attributes of attribute type “5”, the type that was defined in metadata table 41. Thus, attributes of a new attribute type can be added to the data table similarly to attributes of an existing attribute type. No reformatting of the data table is necessary.

Of course, FIGS. 1-5 are only representative of particular embodiments of the present invention. The data table could include a variety of information, including, but not limited to, the following: data ID, entity ID, entity name, a set of primary key values, attribute ID, attribute name, metadata ID, a string value of several thousand characters (to hold the attribute), a set of foreign key names and values, and status, among other information. Likewise, the metadata table can also hold a variety of information, which can include the following: metadata ID, entity ID, attribute ID, entity name, attribute name, attribute type, default value, required indicator, minimum and maximum values, format, permitted access, primary key sequence, foreign key sequence, and status, among other information.

As these example embodiments demonstrate, structuring a database in this extensible manner offers several benefits. In addition to the benefits already mentioned, logical tables of relationships can also be established within the data table. As such, new tables can be added by adding rows to the metadata table and data table, without needing to use a DDL. Thus, the extensible format allows for dynamic flexibility in database management. Furthermore, one could use sets of primary and foreign keys, although not illustrated in the above example, to permit relationships among entities and attributes to be established and maintained, by using database-specific algorithms.

For this example embodiment, common logic and database-specific algorithms are used in data access objects to access and update any row in the data table, instead of requiring the use of specialized SQL statements that are different for each table in the schema used. The metadata is used for describing the information in the data table, and a standard format using unique algorithms is used for data queries. Because a standard format is used, the same query can be used repeatedly with different parameter values, which results in faster response times for batch-prepared SQL statements that are parsed one time and cached by the database server engine. Furthermore, database development time is reduced significantly, because developers can reuse the standard SQL statements for query, update, delete, and insert processing for multiple entities. Also, the logic used includes standard processing using unique algorithms to convert data from conventional database table designs to the present invention's extensible design.

FIG. 6 illustrates an extensible database system in which transformation module 62 is operable to import and export data into and out of data table 60 and metadata table 61. In this example embodiment, unique algorithms are used for a set of transformation logic, embodied in transformation module 62, which may include processors, embedded logic, memory, and/or interfaces. Transformation module 62 can query the extensible database, comprising data table 60 and metadata table 61, process a query result, and transform the result into objects for processing. This can be done a number of ways, including, but not limited to, using Java reflection and database-specific algorithms. Transformation logic can also be provided to convert data from a conventional relational data format to the extensible data format using metadata and unique algorithms. Also, standard transformation logic can be used to obtain data from Java objects using reflection and database-specific algorithms, and create the parameters for the standardized SQL-prepared statements (e.g., using batch-prepared statements for increased processing speed, as an option). Although Java can be used for implementing the transformations for this example embodiment, other suitable programming languages also can be used for implementing the transformation algorithms with no loss of generality.

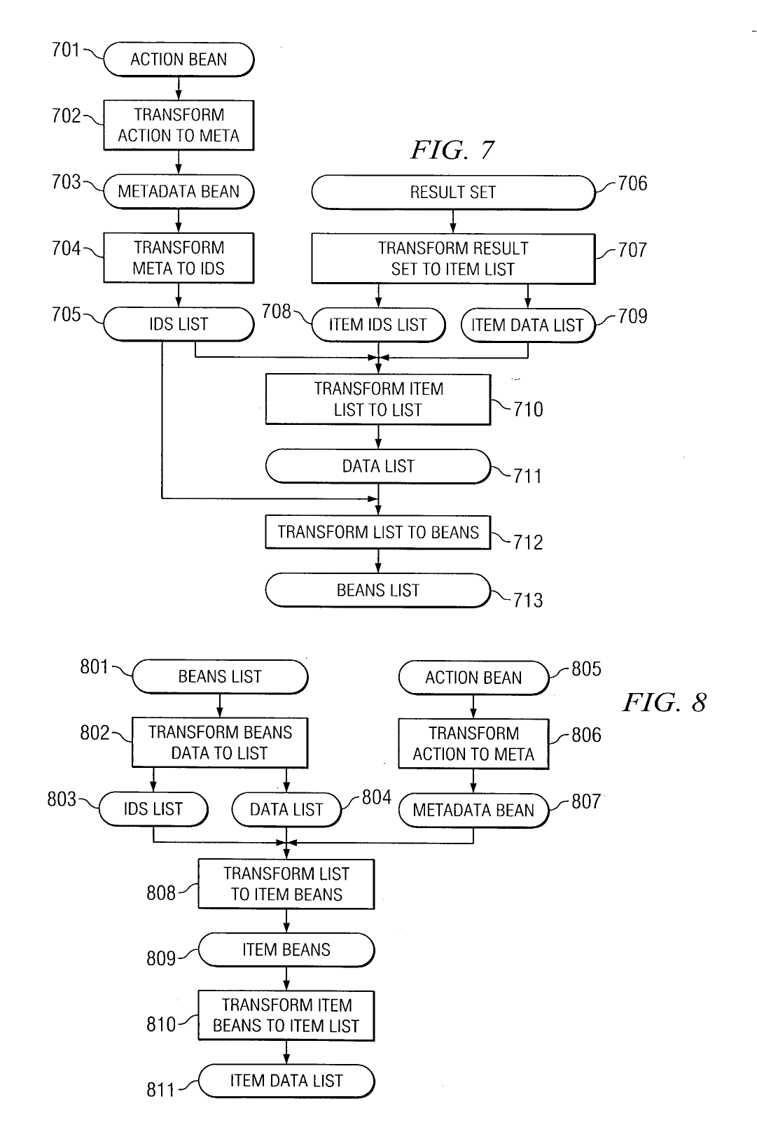

FIG. 7 illustrates a Petri net depicting the transformation logic used in a particular embodiment of a transformation module to prepare objects for processing from information stored in an extensible database.

Each row of the data table used in conjunction with this embodiment of the transformation logic has the following fields: data ID (dId), entity ID (entityId), four primary keys (pk1, pk2, pk3, and pk4), attribute ID (attributed), entity name (entityName), four primary key names (pk1Name, pk2Name, pk3Name, pk4Name), attribute name (attributeName), metadata ID (mId), value, four foreign key names (fk1Name, fk2Name, fk3Name, fk4Name), and four foreign key values (fk1value, fk2Value, fk3Value, and fk4Value). The metadata for this data table includes the following information: metadata ID (mId), entity ID (entityID), attribute ID (attributeId), entity name (entityName), primary key sequence (pkseq), and foreign key sequence (fkSeq). The transformation logic that is used to transform this information into objects for processing begins with ActionBean 701 and ResultSet 706.

ActionBean 701 encapsulates information that is used by an application for processing database requests. The data in ActionBean 701 can be obtained from a knowledgebase or created while the application is executing. The field in ActionBean 701 that is used for the transformations is called ActBean. ActBean has the name, or names, of the objects being inserted, updated, or deleted.

ResultSet 706 holds a result of an SQL request of a database (e.g., a select, update, delete, or insert) in the form of rows and columns of data with accompanying metadata describing the result.

In block 702, a TranformActionToMeta algorithm transforms the information in ActionBean 701 into metadata. The TranformActionToMeta algorithm extracts the value of the ActBean from ActionBean 701. It then retrieves the metadata for ActionBean 701 by matching the value of ActBean to the entity name value in the retrieved metadata information, and saves the metadata information in MetadataBean 703.

The metadata information in MetadataBean 703 is then converted to a list of IDs by a TransformMetaToIds algorithm in block 704. The TransformMetaToIds algorithm gets all the attribute name (or attributeName) values from MetadataBean 703 for that entity and creates a list of IDs using all the attributeName values which is output as IdsList 705.

ResultSet 706 is similarly transformed in block 707 by a TransformResultSetToItemList algorithm. The TransformResultSetToItemList algorithm extracts the metadata from ResultSet 706, including the number of columns. The algorithm then loops through the metadata from ResultSet 706, getting each column name. These column names are placed into ItemIdsList 708. The TransformResultSetToItemList algorithm also loops though the metadata from ResultSet 706, getting each column datatype, which is placed in another list.

The TransformResultSetToItemList algorithm then does a loop within a loop, the outer loop being for each row in ResultSet 706, the inner loop being for each column in ResultSet 706. The inner loop uses the column datatype to call the appropriate method (e.g., methods “getinteger” and “getString”) on ResultSet 706 and creates an object to hold each column value retrieved. This object is placed into a set of lists within ItemDataList 709, with one entry for each column within each row in ResultSet 706.

ItemIdsList 708, ItemDataList 709, and IdsList 705 are then input into block 710 where a TransformItemListToList algorithm transforms ItemDataList 709 into DataList 711. The algorithm loops through ItemIdsList 708 to find a match on the string “attributeName”, and saves the position in the list where it is found as “attributePos”. It also loops through ItemsIdsList 708 to find a match on the string “value”, and saves the position in the list where it is found as “valuePos”. In the event the two matches do not result in a valid position in the lists the algorithm produces an exception.

Additionally, the TransformItemListToList algorithm loops through ItemDataList 709, getting the attributeName using the position found in “attributePos”, getting the value using the position found in “valuePos”, putting the value into a list for each attributeName that matches to a value in IdsList 705, and after all the values in IdsList 705 are checked, adding that list of values to DataList 711, which is a list of lists, each value in the inner lists being a value that was obtained from ItemDataList 709.

DataList 711, IdsList 705, and ActionBean 701 are then input into block 712, where a TransformListToBeans algorithm populates one or more bean objects using reflection and lists of IDs and values. The TransformListToBeans algorithm creates an empty list, called “beans”, for the bean objects that will be created. The algorithm then gets the value of ActBean from ActionBean 701 and gets the name of the class for the bean using the value of ActBean. The algorithm then loops through DataList 711.

For each of the lists of values in DataList 711, the algorithm gets the list of values within DataList 711, calling this list “values”. The algorithm also instantiates a bean object using the name of the class for the bean found earlier. The algorithm then gets the list of declared methods in the bean object, calling this list “methods”.

The algorithm then loops through IdsList 705, getting the “id” in DataList 711 and getting the “value” in the “values” list. If “value” is null, the algorithm continues; the value in the bean does not need to be set. The algorithm creates a method name by adding the string “set” before the “id”, calling it “setMethodName”.

Within this loop through IdsList 705, the algorithm also loops through the “methods” list, getting the name of the method, calling it “beanMethodName”. If the value of the “setMethodName” is equal to, ignoring case, the value of the “beanMethodName”, and the method has public access, and the method takes exactly one parameter, then the algorithm uses the parameter type of the one parameter to convert the “value” to the appropriate parameter type (e.g., converting a string to an integer if needed), and sets the “value” in the bean object using the method of name “setMethodName”.

If there was no match between the values of “setMethodName” and “beanMethodName”, then the algorithm gets the superClass (i.e. ancestor) of the bean object and recursively repeats the loop through IdsList 705, looping through the methods in the superClass. This populates a value into the bean object's superClass.

The resultant list of beans this produces is output as BeansList 713, which is a list of bean objects that have been populated with values from the database. These beans objects can then be used for processing.

Another set of transformation logic is shown in FIG. 8. FIG. 8 illustrates a Petri net depicting the transformation logic used in a particular embodiment of a transformation module to import objects from processing into an extensible database, similar to that used in conjunction with the transformation logic described above in regard to FIG. 7. Each row of the data table used in conjunction with this embodiment of the transformation logic has the following fields: data ID (dId), entity ID (entityId), four primary keys (pk1, pk2, pk3, and pk4), attribute ID (attributeId), entity name (entityName), four primary key names (pk1Name, pk2Name, pk3Name, pk4Name), attribute name (attributeName), metadata ID (mId), value, four foreign key names (fk1Name, fk2Name, fk3Name, fk4Name), and four foreign key values (fk1value, fk2Value, fk3Value, and fk4Value). The metadata for this data table includes the following information: metadata ID (mId), entity ID (entityID), attribute ID (attributeId), entity name (entityName), primary key sequence (pkSeq), and foreign key sequence (fkSeq).

The transformation logic in FIG. 8 begins with BeansList 801, a list of bean objects that have been populated with values from an application or from the database, and ActionBean 805.

Similar to ActionBean 701 in FIG. 7, ActionBean 805 encapsulates information that is used by an application for processing database requests. The data in ActionBean 805 can be obtained from a knowledgebase or created while the application is executing. The field in ActionBean 805 that is used for the transformations is called ActBean. ActBean has the name, or names, of the objects or beans being inserted, updated, or deleted.

In block 806, the information in ActionBean 805 is transformed into metadata by a TranformActionToMeta algorithm. The TranformActionToMeta algorithm extracts the value of the ActBean from ActionBean 805. It then gets the metadata for ActionBean 805 by matching the value of ActBean to the entityName value in the retrieved metadata information, and saves the metadata information in MetadataBean 807, which holds the metadata for this specific entityName.

Similarly, BeansList 801 is transformed into IdsList 803 and DataList 804 by block 802, using a TransformBeansDataToList algorithm. This algorithm takes BeansList 801 as input and creates two list objects, IdsList 803 and DataList 804, to be populated. The algorithm then loops through the list in BeansList 801. For each “bean” object in BeanList 801 retrieved, the algorithm gets its list of object values. A list object is created that is to be placed into DataList 804 with the “bean” object's attribute values. The algorithm gets the name of the class for the “bean” object and the list of methods in the “bean” object's class, and loops through the list of method names.

For each “beanMethodName” string in the list of method names, if the value of the “beanMethodName” starts with “get”, and the method has public access, and the method takes no parameters, the algorithm invokes the method of the “bean” object to obtain a “value” object, and adds the “value” object to DataList 804. If the bean is also the first bean, the algorithm extracts the part of the “beanMethodName” that follows “get”, which is the attribute name, and loads that to IdsList 803, as well. By this process, the TransformBeansDataToList algorithm creates and populates IdsList 803 and DataList 804.

IdsList 803, DataList 804, and MetadataBean 807 are then input to block 808. In block 808, a TransformListToItemBeans algorithm uses IdsList 803, DataList 804, and MetadataBean 807 to create ItemBeans 809.

First, the algorithm instantiates a new “holdDataItem” object, which can hold the various entries in the fields of the data table. It then loops through the list of attributes in MetadataBean 807. For each “metabean” object in MetadataBean 807 retrieved on one iteration of the loop, the algorithm loads the values of the entityId, entityName, and various primary and foreign key names into the “holdDataItem”.

The algorithm then loops through the list in DataList 804. For each “values” list object in DataList 804 retrieved on one iteration of the loop, the algorithm populates the “holdDataItem” object as follows. The algorithm loops through the list of IDs in IdsList 803. For each ID in IdsList 803, the algorithm gets the “value” string from the “values” list object. If the “id” from IdsList 803 is equal to one of the primary key names in “holdDataItem”, then the value of that primary key is set to “value”. If the value is an integer, the primary key is set to that value, otherwise the primary key is set to the hashcode number of the value. The hashcode number is equal to the result from Java's object hashcode method. Similarly, if the “id” from IdsList 803 is equal to one of the foreign key names in “holdDataItem”, the corresponding foreign key is set to “value”.

The algorithm next instantiates an “items” list that is the same size as IdsList 803. The algorithm loops through the list of attributes in MetadataBean 807, iterating through the entire list to get the “id” string object from IdsList 803. On each iteration, the algorithm gets the “value” string from the “values” list object and begins a sub-loop through the list of attributes in MetadataBean 807, finding the “metabean” object in the list with a value of attributeName that matches to “id”.

Lastly, the TransformListToItemBeans algorithm instantiates a new “dataitem” object, which can hold the various entries in the fields of the data table, and populates it with the entries found in the “holdDataItem” object and the entries found in the “metabean” object. This populated “dataitem” object is then added to ItemBeans 809. At the completion of these loops, ItemBeans 809 is entirely populated.

Finally, ItemBeans 809 is transformed in block 810 into ItemDataList 811, a set of lists within a list with one entry for each column within each row in ResultSet 805. This transformation in block 810 uses the TransformItemBeansToItemList algorithm. For example, if BeansList 801 contains 5 “beans”, and each “bean” contains 26 object values, then ItemDataList 811 is a list containing 5 lists where each of the 5 lists contains 26 objects. ItemDataList 811 can then be added to the extensible database using standardized SQL.

Of course, FIGS. 7 and 8, and their associated descriptions herein, are provided for illustration and example only. It will be recognized by those of ordinary skill in the art that various algorithms and programming techniques may be employed within the teachings of the present invention in implementing the invention disclosed herein.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A system for storing information in an extensible database, comprising:
a data table for storing information regarding a plurality of logical entities;
each logical entity having one or more respective attributes;
each attribute being one of a plurality of attribute types;
a metadata table including a plurality of metadata table rows, wherein each metadata table row defines parameters for one of the plurality of attribute types; and
the data table including a plurality of data table rows, each data table row corresponding to one of the respective attributes of one of the plurality of logical entities.

2. The system of claim 1, further comprising a transformation module operable to import and export data into and out of the data table.

3. The system of claim 2, wherein the transformation module is further operable to convert data from a traditional relational data format to an extensible data format.

4. The system of claim 2, wherein the transformation module is further operable to:
query the data table;
process a query result; and
transform the query result into objects for processing.

5. The system of claim 4, wherein the objects are Java objects.

6. The system of claim 4, wherein the transformation module uses Java reflection to transform the query result into objects for processing.

7. The system of claim 2, wherein the transformation module is further operable to define parameters for an additional attribute type by adding an additional metadata table row to the metadata table.

8. The system of claim 2, wherein the transformation module is further operable to add an additional attribute of an existing logical entity by adding an additional data table row to the data table.

9. The system of claim 2, wherein the transformation module is further operable to add an additional attribute for an additional logical entity to the data table by adding an additional data table row to the data table.

10. A method of storing information in an extensible database, comprising:
characterizing one or more logical entities in terms of one or more attributes, wherein each attribute is of an attribute type;
defining parameters for each attribute type in a metadata table, wherein the metadata table comprises metadata table rows, and wherein each metadata table row defines parameters for one attribute type; and
storing data representing the attributes in a data table, wherein the data table comprises data table rows, and wherein each data table row corresponds to one attribute.

11. The method of claim 10, further comprising importing and exporting data into and out of the data table using a transformation module.

12. The method of claim 11, further comprising converting data from a traditional relational data format to an extensible data format using the transformation module.

13. The method of claim 11, further comprising using the transformation module to:
query the data table;
process a query result; and
transform the query result into objects for processing.

14. The method of claim 13, wherein the objects are Java objects.

15. The method of claim 13, wherein the transformation module uses Java reflection to transform the query result into objects for processing.

16. The method of claim 11, further comprising using the transformation module to define parameters for an additional attribute type by adding an additional metadata table row to the metadata table.

17. The method of claim 11, further comprising using the transformation module to add an additional attribute to an existing logical entity by adding an additional data table row to the data table.

18. The method of claim 11, further comprising using the transformation module to add an additional attribute for an additional logical entity to the data table by adding an additional data table row to the data table.
